(19) United States
(12) Patent Application Publication
(10) Pub. No.: US 2003/0167467 A1
(43) Pub. Date: Sep. 4, 2003

(54) User-customized interactive television ticker, including a feature for viewer exclusion of ticker topics

(75) Inventors: Paul G. Allen, Mercer Island, WA (US); David P. Billmaier, Woodinville, WA (US); Michael J. Markman, Kirkland, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: digeo, inc., Kirkland, WA

(21) Appl. No.: 10/091,363

(22) Filed: Mar. 4, 2002

(51) Int. Cl. G06F 3/00; H04N 5/445; G06F 13/00; G06F 15/173

(52) U.S. Cl. 725/47; 709/224

(57) ABSTRACT

The ticker for an interactive television system has user-customizable features, including a feature to exclude ticker topics dynamically from the display screen while the ticker is being presented and without the need to navigate to a static preferences screen. This allows the user to view only ticker items of interest. Excluded ticker topics are readily re-included without the use of a static preferences screen. Navigation and scrolling controls are used to customize the ticker presentation for the non-excluded ticker topics. Finer granularity of user customization within a topic itself is provided, including an ability to change modes or add content to a ticker. Implicit profiling is used in one implementation to customize the ticker by collecting viewer behavior data.

### CROSS-REFERENCE TO RELATED APPLICATION

This application is related to U.S. patent application Ser. No. ______ (Attorney Docket No. 260042.492; digeo Reference No. 770), entitled “NAVIGATION IN AN INTERACTIVE TELEVISION TICKER,” with inventors David P. Billmaier and Michael J. Markman, filed concurrently herewith, assigned to the same assignee as the present application, and incorporated herein by reference in its entirety.

### BACKGROUND OF THE INVENTION

1. Field of the Invention

This disclosure relates generally to presentation of information on a display device, and in particular but not exclusively, relates to an interactive television “ticker” having user-customizable features, including a feature for viewer exclusion of ticker topics.

2. Description of the Related Art

It is relatively common to see television programs accompanied by a scrolling “ticker.” The term “ticker” derives from the fact that information in the ticker scrolls sequentially across the bottom of a television screen in a manner analogous to a stock market ticker tape. However, instead of simply including stock market information, current tickers carry a wide variety of other types of information. For instance, tickers that are present on sports channels typically scroll game scores or game schedules. Tickers that are present on news channels scroll the latest headlines, weather reports, or brief news updates.

Tickers are generally encoded in the same analog or digital signal as the television signal. For instance, with Motion Pictures Experts Group (MPEG) digital encoding, the ticker information is included along with the MPEG stream. A graphics generator or other mechanism generates the ticker information at a production studio (or other location) and then combines the ticker information with the television signal. The television signal is then broadcast to viewers. Obviously, with this current implementation, viewers have no control over the content, format, layout, or other presentation aspect of the ticker on their television (including whether or not to even display the ticker), since the production studio maintains such control and since the ticker information is integrated with the received television signal.

Because of this lack of control, viewers share common frustrations with tickers. For example, most tickers scroll from left to right at the bottom of the television screen at a certain speed set by the production studio. Many times, a stock price or sports score of interest to the viewer has scrolled by during a moment that the viewer was not looking at the television screen or was otherwise distracted, thereby causing the viewer to miss the ticker item. As a result, the viewer is forced to wait until the ticker item scrolls by again. This can be an annoying wait for the viewer if there are a large number of ticker items, which are of no interest to the viewer, to scroll through before the item of interest reappears. This can be very inconvenient if the viewer is in a rush and cannot afford the spend time to watch a ticker.

This problem highlights the fact that conventional tickers generally are not tailored to any particular viewer. They are broadcast to all viewers and are not intended to target any particular market or viewer segment. As a result, broadcasters are forced to include content in tickers that are only of a general nature, or if they want to provide more details and topics in the tickers, they are forced to increase the quantity of information scrolled in tickers so that they can ensure some level of specificity for each ticker topic. The consequence of this action is that, for the most part, viewers pay attention to only a portion of the ticker items that are scrolled and ignore the remainder, but are nevertheless still forced to view all of the content if they wish to locate a ticker item of interest. This reduces the effectiveness of the ticker's intent: to provide viewers with a quick and convenient mechanism for obtaining information.

Because the content, layout, sequence of presentation, and other format of tickers are predetermined by the production studio, a particular predetermined format that may suit one viewer may be annoying to another viewer. For instance, one viewer may only wish to see final scores of football games, while another viewer wishes to see up-to-the-minute scores. Both of these viewers would be dissatisfied if the predetermined format of the ticker only presented scores at the end of each quarter of football games.

Interactive television is increasing in use and popularity. With interactive television, viewers can now access the Internet through their television sets, as well as being able to receive interactive programming and content. Using interactive television tickers, interactive service providers can deliver national news, sports, entertainment, and business feeds to interactive television subscribers. Although such interactive television tickers provide some user/viewer control, such as being able to select subjects of interest through a settings page or preferences screen, the ticker itself behaves in much the same way as a broadcast television ticker—the viewer has little control over the presentation of information in the ticker (e.g., if the viewer misses an item, the viewer usually has to wait until that item scrolls by again).

Moreover, the static preferences screens are inconvenient to use, since they often need to be accessed and navigated through (via complex multiple menus) whenever viewers need to change a format feature of their ticker. Static preferences screens are also generally inadequate in situations where the viewer wishes to have different formats for different ticker topics—the settings in the preferences screen will be applied to all ticker topics, and cannot be tailored differently to different ticker topics.

### BRIEF DESCRIPTION OF THE SEVERAL VIEWS OF THE DRAWING(S)

Non-limiting and non-exhaustive embodiments of the present invention are described with reference to the following figures, wherein like reference numerals refer to like parts throughout the various views unless otherwise specified.

FIG. 1 is a block diagram of an example interactive video casting system that can implement user-customized tickers in accordance with an embodiment of the invention.

FIG. 2 is a block diagram illustrating example components that can be included in the system of FIG. 1 to provide user-customized tickers in accordance with an embodiment of the invention.

FIG. 3 is a block diagram of an embodiment of a client terminal that can be used in the system of FIG. 1 to present user-customized tickers.

FIGS. 4-6 illustrate user-customizable ticker operations according to various embodiments of the invention.

FIG. 7 is a flowchart illustrating user customization of a ticker in accordance with an embodiment of the invention.

### DETAILED DESCRIPTION

Embodiments of a ticker having user-customizable features, including a feature to exclude ticker topics, are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Moreover, the term “ticker” as used herein is intended to generally describe a presentation of information on a display screen, such as a display screen for a television, and is not intended to be limited solely to implementations where the information is presented in a manner to exactly mimic a stock market ticker. In one embodiment, the ticker can comprise text and graphics that are scrolled or otherwise presented in a region of the display screen, along with a television image (such as an image from a live broadcast or from a recorded program). Various embodiments will be described herein in the context of “scrolling” the ticker information. It is to be appreciated that the term “scrolling” is merely illustrative of a technique to present dynamic ticker information, and that this term, in some embodiments, can encompass implementations where the ticker information is presented via screen segments of information, text segments, one-word-at-a-time, and the like, rather than the traditional format of one-character-at-a-time typically associated with stock market tickers.

As an overview, an embodiment of the invention provides a ticker that can be implemented in a television system, such as an interactive television system. The ticker has user-customizable features, including a feature to exclude ticker topics dynamically from the display screen while the ticker is being presented and without the need to navigate to a static preferences screen (or settings page). Thus, the user can view only ticker items of interest, and need not be presented with the remainder of the ticker items. Excluded ticker topics can also be readily re-included without the use of a static preferences screen, and are instead re-included (or excluded) using the same screen interface as that through which the ticker is rendered. Various navigation and scrolling controls are also available and can be used to customize the ticker presentation for the non-excluded ticker topics, such as a “lock” feature that causes the ticker to loop through a specific (non-excluded) category or subcategory only.

In one embodiment, viewers may exclude topics by pressing one or more buttons on a remote control device, while the ticker is being presented on the display screen and without having to navigate to a preferences screen. According to one possible implementation, the topic is “grayed out” on the display screen and bypassed during the scrolling, rather than being completely removed from the ticker. This allows the ticker to “skip” from one non-excluded topic to another, thereby reducing the amount of non-relevant ticker information that is presented to the viewer and the scroll time to cycle through the ticker information.

In an embodiment, finer granularity of user customization within a topic itself is provided. For example, different modes to show scores at different stages of football games or other sporting events are available and can be customized by the user. As another example, weather information in the ticker can be customized to add a geographic location, or traffic information can be customized to track the routes used by the viewer. In an embodiment, implicit profiling may be used to customize the ticker. For instance, television viewing habits, web pages “surfed,” click history, or other information indicative of viewer behavior can be collected and used to provide customized ticker items and other content to the viewer, including use of such implicit profile information to exclude topics that are not of interest to the viewer. In another embodiment, explicit profile information may be used as a technique for customization. For example, if the viewer fills out a profile form indicating hunting for sport as his interest, this profile information can be used to exclude ticker topics that may be inconsistent or irrelevant with this interest, such as news releases reminding interested individuals to attend an upcoming wildlife conservationists rally.

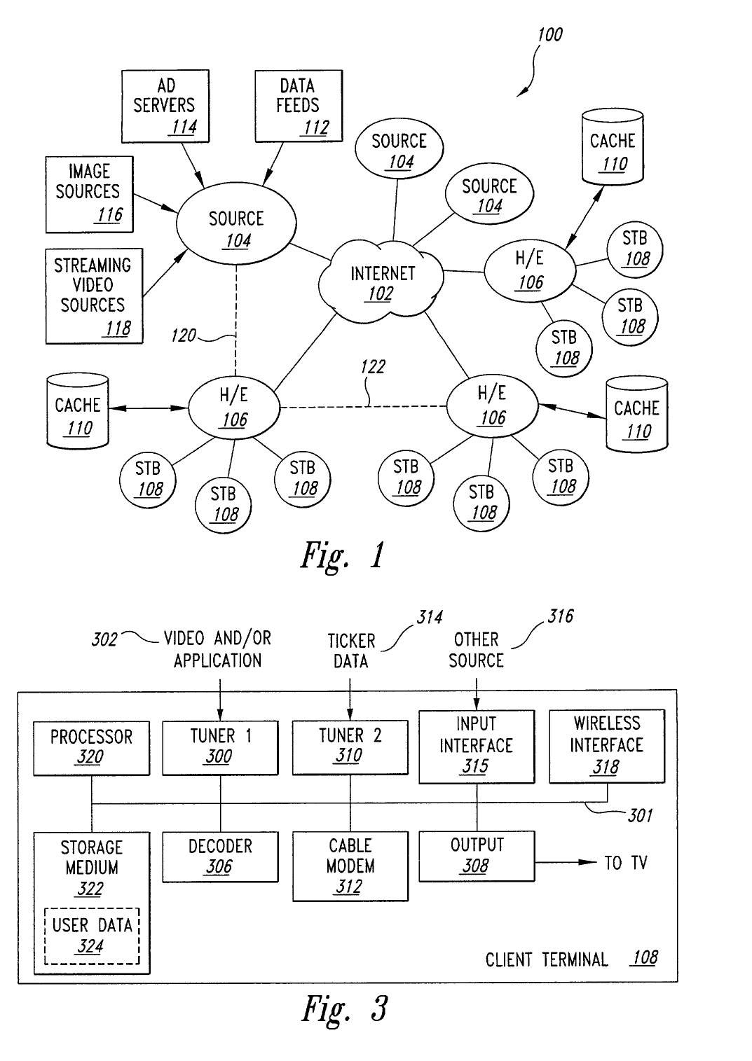

FIG. 1 shows an example of an interactive video casting system 100 for distributing ticker content, Internet content, and television content according to an embodiment of the invention. In accordance with an embodiment of the present invention, the system 100 can be integrated with a cable television distribution system to provide interactive television tickers. It is to be appreciated that in another embodiment, tickers having user-customizable features may be implemented in systems that are not necessarily interactive in nature. The system 100 includes an Internet 102, a plurality of content sources 104, a plurality of distribution centers (depicted as the head-ends or H/Es 106), and a plurality of client terminals 108 (depicted as set top boxes). In addition, a content source 104 is depicted as receiving data from data feeds 112, advertisement servers 114, image sources 116, and streaming video sources 118. The content source 104 may also receive content from a broadcast video source. For the sake of clarity and to avoid clutter, not all of these sources are shown in FIG. 1 for each content source 104.

The plurality of content sources 104 is coupled to the Internet 102. For example, a content source 104 may comprise a web site portal such as Go2Net.com™, or a news web site such as CNN.com™, or other types of sources. Each content source 104 may have various data feeds 112, servers 114, and sources 116/118 coupled to it.

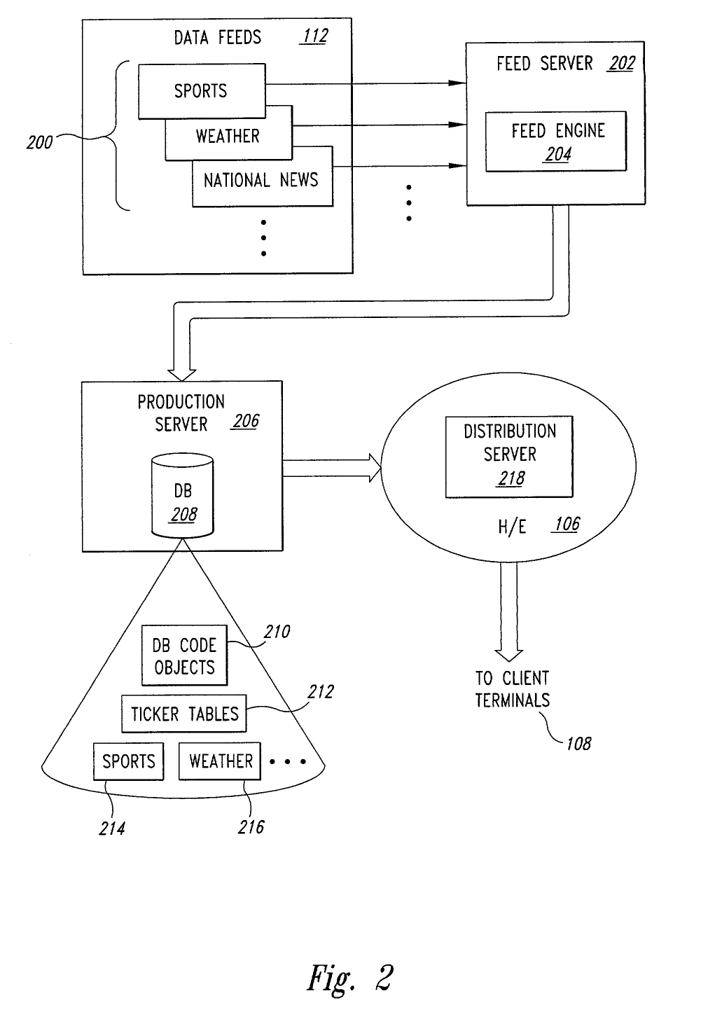

For example, news or stock quote feeds 112 (including data for tickers) may be fed into the content source 104. Servers 114 may provide advertisements for insertion into multimedia content delivered by the content source 104. Sources 116 and 118 may provide images 116, streaming video 118, and other content to the content source 104. Various other feeds, servers, and sources may also be coupled to the content source 104 of FIG. 1. An example configuration of components that can be integrated with the system 100 to provide ticker information to client terminals 108 is shown in FIG. 2.

The Internet 102 comprises a network of networks and is well known in the art. Communications over the Internet 102 can be accomplished using standard protocols such as transmission control protocol/internet protocol (TCP/IP), hypertext transfer protocol (HTTP), file transfer protocol (FTP), or other protocols. The Internet 102 is coupled to the plurality of distribution centers 106, and each distribution center 106 is in turn coupled to a plurality of client terminals 108, which may comprise a set top box, a PC, an interactive television set, or another type of communication device or display device.

In alternative or in addition to the Internet 102 being used to distribute multimedia content (including ticker data) from the content sources 104 to distribution centers 106, communications channels or networks 120 (which can include satellite delivery sources/networks) apart from the Internet 102 may couple one or more content sources 104 to one or more distribution centers 106. One example of such an alternate path for communications is illustrated by a first dashed line 120 in FIG. 1. Alternately or additionally, peering connections may exist between distribution centers 106. One example of such peering is illustrated by a second dashed line 122 in FIG. 1. Other communications configurations are also possible and are included within the scope of the present invention.

Caches 110 may be provided at (or otherwise coupled to) the distribution centers 106. Such caches 110 may be used to increase the performance in the delivery of multimedia content (including ticker data) to the client terminals 108. For example, larger files for video and other high bandwidth content may be stored in such caches 110, which may be closer-in-time to the client terminals 108 than to the content sources 104. In addition, reliability and guaranteed bandwidth may be provided because the Internet 102 is not in-between such caches 110 and the client terminals 108. In one embodiment, the caches 110 or other storage media in the system 100 can store ticker information, rather than or in addition to having such information buffered, cached, or otherwise stored at the client side.

In an embodiment, servers may be present in the distribution centers 106, with such servers including or being coupled to the caches 110 or other storage media. Alternatively or in addition, these servers may be located remotely from but still communicatively coupled to the distribution centers 106, via the Internet 102 or other communications channels or networks. Examples of such servers that can be used in connection with providing ticker information to client terminals 108 are shown in FIG. 2.

In accordance with one embodiment of the invention, different or multiple portals may be used to access the information provided through the interactive video casting systems of FIG. 1, based on the type of client terminal being used by the end user. That is, for example, a television portal may be provided for an end user that uses a television set coupled to the client terminal 108 to access the information. A PC portal may be provided for an end user that uses a PC to access the information. Portals can be provided for end users that use cellular telephones, personal digital assistants (PDAs), audio devices, and the like to access the interactive video casting system 100 of FIG. 1.

Such portals may be provided in several possible ways. In one embodiment, the client terminal (e.g., the end user's display device or audio device) can be suitably configured with an adapter that includes hardware and software. The adapter converts the television signals, the Internet or web page content, or other information provided from the interactive video casting system into a digitized format or other format that is compatible with the operational features of the particular client terminal 108.

In another embodiment, a cable service provider can deliver signals having different formats to the various client terminals 108, with the client terminals not necessarily having special adapters. Therefore, as an example, the cable service provider or other party can generate/deliver information (e.g., television programming, web page content, ticker information, and the like) having a format that is compatible for end users that receive the information via a television set. The cable service provider or other party can also generate/deliver the same information (e.g., simultaneously with the television portal on the same communication link, separately on a different communication link, on-demand independent of the television portal, and the like) using a format that is compatible with end users that receive the information via PCs, PDAs, cellular telephones, and the like. Thus, the term “interactive video casting system” is used to describe generally a system that can deliver video information and other information over any network and any network-compatible device by broadcasting, multicasting, or unicasting. An “interactive television system” is one type of or one means of access to an “interactive video casting system.”

FIG. 2 is a block diagram illustrating example components that can be included in the system 100 of FIG. 1 to provide data for tickers in accordance with an embodiment of the invention. The data feeds 112 include a plurality of different ticker data feeds 200 that provide a variety of different topical data that can be displayed in a ticker. For instance, the different ticker data can include sports data, weather data, national news, and so forth. The sources that can provide this data can include entities such as Reuters™, The Sporting NewS™ (TSN), Associated Press™ (AP)™, and others. In one embodiment, the ticker data from the data feeds 200 comprises “raw” unformatted data (e.g., data with minimal or no formatting or graphics).

The raw ticker data is provided to a feed server 202. In an embodiment, the feed server 202 operates as a content aggregator that pulls or otherwise receives the raw ticker data from the data feeds 200. The feed server 202 also performs data manipulation on the received ticker data to manipulate the data into a database format so that the data can be indexed and stored. A feed engine 204, which can be embodied in software or other machine-readable instructions stored on one or more machine-readable media according to an embodiment, can reside and run in the feed server 202 to perform at least some of this data manipulation.

The feed server 202 is coupled to provide the manipulated ticker data to a production server 206. The production server 206 includes or is otherwise coupled to a database 208. The feed engine 204 calls on the database 208, and instructs the database 208 where to place the various ticker data. For example, the database 208 can include a plurality of database code objects 210 that cooperate with ticker tables 212 (such as a sports table 214, a weather table 216, and so forth) to index or store ticker data. The feed engine 204 calls the database 208 and identifies the database code objects and ticker tables where the ticker data is to be stored.

The various components of the database 208, such as the ticker tables 212, can also be configured in a manner that optimizes the organization and distribution of the ticker data. For example, ticker data unique to various geographic regions can be segregated from or otherwise identifiable from each other, so that ticker data that is relevant to only particular client terminals 108 need not be broadcast to all client terminals. For instance, California weather information can be segregated from Oregon weather information in the database 208 in a manner that client terminals 108 of California users do not receive Oregon weather information, unless specifically requested. This feature improves transmission efficiency and transmission time, since the bandwidth of communication paths to certain client terminals 108 are not clogged by non-relevant ticker data.

In an embodiment, the production server 206 can also perform data manipulation, such as before the data is stored in the database 208, while it is stored in the database 208, or after the data is retrieved from the database 208 for transmission to client terminals 108. For instance, the production server 206 can perform data manipulation to place the ticker data into a format that is “consumable” or otherwise compatible with operating software of the client terminals 108. For instance, the production server 206 can place the ticker data into formats such as hypertext markup language (HTML), extensible markup language (XML), or other suitable formats.

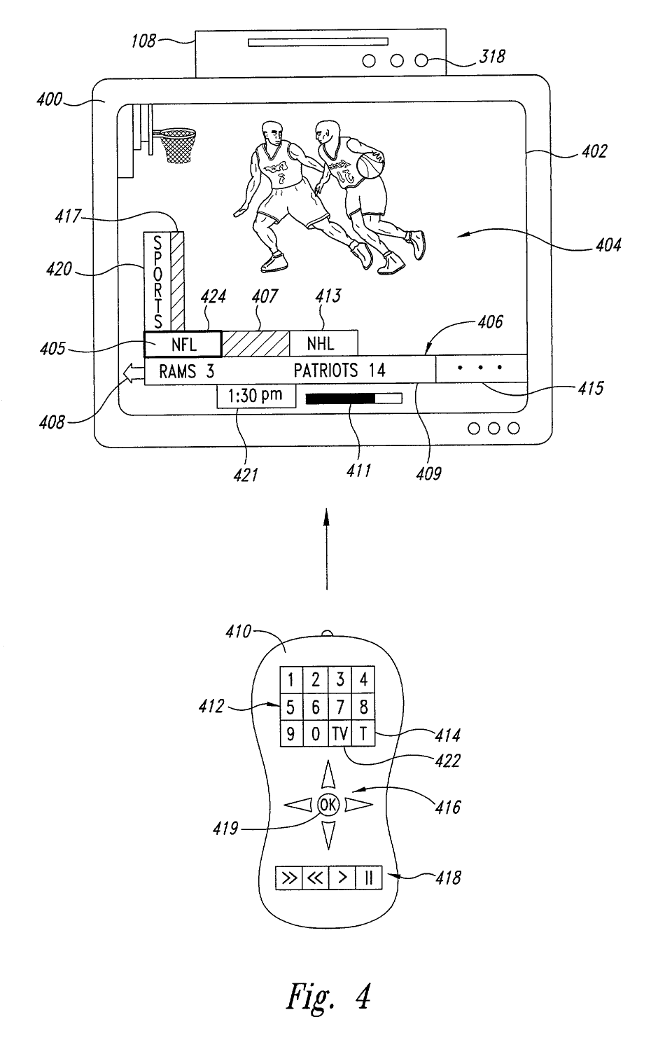

The production server 206 is coupled to provide ticker data from the database 208 to one or more distribution servers 218, which may be located in or otherwise communicatively coupled to a distribution center 106 (such as a head-end). The distribution server 218 operates to provide the ticker data to the client terminals 108 via several possible communication paths or channels, as will be described with reference to FIG. 3. In one embodiment, the distribution server 218 or other server(s) at the distribution center 106 can also perform the user-customized manipulation of the ticker (such exclusion of ticker topics, content and format customization, and so on) alternatively or in addition to having such user controllable operations performed at a client terminal 108. This server-side implementation may be present, for example, where a particular client terminal 108 may have limited software, storage, and processing capacity to perform the appropriate user controllable operations—therefore, the operations are performed remotely at a server rather than locally at that client terminal 108, and then a ticker presentation reflecting the user customization (e.g., a ticker data with certain topics excluded) is sent from the server to the client terminal 108 for display.

It is to be appreciated that the components shown in FIG. 2 are merely illustrative of the various components of one embodiment that can be used to provide ticker information. For example, other embodiments can use more or fewer servers, as well as different components, to perform the various operations. Moreover, the various servers and their components (such as the feed engine 204 and the database 208) can be distributed elsewhere in the system 100, instead of or in addition to the locations shown in FIG. 2. There may be multiple feed servers 202, production servers 206 and databases 208, distribution servers 218, and so on to account for load balancing, redundancy in case of outages or broken connections, and other factors that can affect distribution of ticker information.

FIG. 3 is a block diagram of an embodiment of a client terminal 108 for the system 100 of FIG. 1 that can implement an embodiment of the invention to present tickers having user-customizable features. For the sake of simplicity of illustration and explanation, only the components that are germane to understanding an embodiment of the invention are shown in FIG. 3. It is understood that the embodiment of the client terminal 108 shown in FIG. 3 can have other components different than or in addition to what is shown. Moreover, the various illustrated components may be suitably combined in some embodiments, instead of being separate. It also should be noted that the client terminal 108 is only one embodiment of the invention and that some or all of the components described as embodied in the client terminal 108 can be incorporated into a client television rather than in a separate device. A bus 301 is shown symbolically to depict coupling between the various components.

To briefly describe a client-side embodiment (as opposed to a server-side embodiment mentioned above), the client terminal 108 receives ticker data from the distribution server 218, and then performs the appropriate processing of the data to allow the data to be displayed in a ticker on a display screen of a television set. The client terminal 108 can be passive in that it receives the ticker data (as well as updates) when the data is sent by the distribution server 218, independently of whether the client terminal 108 requested the ticker data (e.g., the distribution server 218 “pushes” the ticker data to client terminals 108). Alternatively or in addition, the client terminal 108 can poll or otherwise explicitly request the ticker data from the distribution server 218, including polling the distribution server 218 for updated data (e.g., the client terminal 108 “pulls” the ticker data from the distribution server 218). In some embodiments, both push and pull mechanisms may be involved.

Ones it receives the ticker data from the distribution server 218, the data can be buffered or cached (if appropriate), and processed for presentation on the display screen of the television set. In an embodiment, software in the client terminal 108 can work in conjunction with a user-customizable ticker template to display the ticker (and its ticker items) in the appropriate scrolling layout, format, locations, time intervals, topics, content, and so forth. This software in the client terminal 108 can also provide the various navigational and selection controls, including those used in connection with excluding a ticker topic or with other customization. In one embodiment where the ticker data is obtained from the Internet 102, this software can comprise browser-based software or other software capable to cooperate with a web browser. According to various embodiments, the ticker can be generated and made interactive through Flash, C++, Java, HTML, or other suitable code or software.

The client terminal 108 comprises a first tuner 300 to tune to a Moving Pictures Experts Group (MPEG) stream 302 or other video source. The stream 302 may include video, live transmission, and/or application code, including corresponding text and graphic resources. In an embodiment where tickers are provided in an integrated manner along with the video signal, the ticker can be received by way of the stream 302. One skilled in the art will recognize that there will be a plurality of streams 302, depending on the number of channels and programs that the cable service provider makes available to the client terminal 108.

The first tuner 300 is coupled to a decoder 306 that decodes the video, application, and/or audio into a format that is compatible with a television set coupled to the client terminal 108. The client terminal 108 may include a second tuner 310. The second tuner 310 can work in conjunction with a cable modem 312 to obtain ticker data 314 from the Internet 102, such as via a Data Over Cable Service Interface Specifications (DOCSIS) connection with the distribution server 218. In addition to the ticker data 314, Internet content can also be received by the client terminal 108 by way of the DOCSIS connection through the second tuner 310 and the cable modem 312.

In addition, the client terminal 108 includes or is coupled to an input interface 315, through which other sources 316 of ticker data can be provided to the client terminal 108. An example of the input interface 315 comprises an out-of-band tuner that can be used to tune to ticker data that is provided from the distribution server 218 via an out-of-band channel. In an embodiment, the out-of-band channel(s) can comprise one or more low-bandwidth frequencies carried on the same coaxial cable used to provide the MPEG streams and the Internet content. The out-of-band channel(s) tuned to by the input interface 315 to receive ticker data can be used alternatively or in addition to the DOCSIS channel tuned to by the second tuner 310 in such an embodiment.

Further alternatively or in addition, the input interface 315 can comprise another television broadcast tuner (such as the first tuner 300) to tune to one or more channels that may be carrying ticker data. For example, ticker data (including updates) may be broadcast in one or more channel frequencies specifically dedicated for transmission of ticker data to client terminals 108. Thus, as an illustration, the first tuner 300 can tune to a channel showing a television program, while the input interface 315 is tuned to receive ticker data (in the form of packets, for example) from a ticker channel to allow a ticker to be simultaneously shown on the same television screen as the television program.

Yet another example of the input interface 315 is an interface to receive outputs of recording devices such as a PVR or a digital video recorder (DVR) that may have ticker data stored therein, which may be received via download. Alternatively or in addition, the input interface 315 can comprise a communication interface, such as an Ethernet connection, a digital subscriber line modem, a wireless communication interface, and so forth, which can provide a link to the server 218 to receive ticker data, for instance.

An embodiment of the client terminal 108 may include a processor 320 to control operation of the various components shown in FIG. 3. The processor 320 may work in conjunction with ticker software or other machine-readable instructions stored on at least one machine-readable storage medium 322. Such software may cooperate with the processor 320 to present ticker data in a ticker template or other screen interface or user interface, configure the format and layout of the ticker displayed on the display screen of the television, control the scroll speed of the ticker, process received user commands, perform user customization of the ticker, obtain ticker data (and updates) from the distribution server 218, and other operations. In an embodiment, the ticker software can be pre-installed in the client terminal 108. In another embodiment, the ticker software may be installed by way of download from the system 100.

An audio and video output subsection 308 of the client terminal 108 receives decoded video and/or other applications (including ticker templates and the ticker data presented therein), and provides the decoded information to a television set. A wireless interface 318 operates to receive commands from a user input device (such as a wireless remote control). Such commands can include user commands to customize the ticker. The wireless interface 318 provides these commands to the processor 320 so that the processor 320 can cooperate with the ticker software to perform the corresponding operation.

In an embodiment of the invention, the storage medium 322 can also store user data 324 comprising user customization settings related to operation of the ticker or viewer behavior data, such as implicit profile data related to viewing habits, Internet surfing, click history, some of which may be obtained via use of cookies in one embodiment, or explicit profile data that may be obtained when the viewer fills out a profile indicating biographic data, interests, hobbies, and the like. As another example, the user data 324 can include saved settings that identify excluded ticker topics. This data can also be stored in other suitable locations in the system 100. In any of these storage locations, multiple sets of user data 324 may be stored, such as in implementations where multiple users in a household log into a same client terminal 108 and where each user may have different preferences as to how they wish to view a ticker.

The storage medium 322 can include cache(s), buffer(s), or other types of storage locations where ticker data may be stored. For example, received sports scores can be stored in the storage medium and retrieved during the appropriate times during the course of the scrolling of the ticker. The ticker data stored in the storage medium 322 can be replaced as updates are received from the distribution server 218. In one embodiment, less time-dependent ticker information (e.g., information that need not necessarily be updated several times per day), including graphics for weather displays, game schedules, and the like, can be downloaded to the storage medium 322 during non-peak television viewing periods (such as late at night), and then retrieved from the storage medium 322 when that piece of information is appropriate for presentation in the ticker.

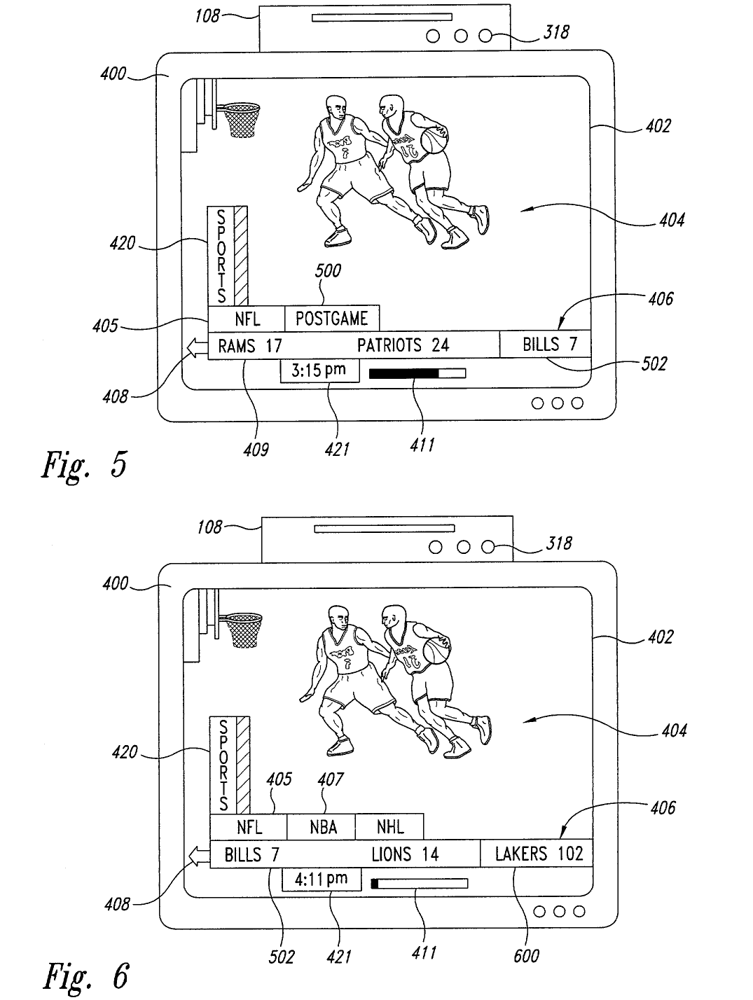

FIGS. 4-6 are television screen shots illustrating user-customizable ticker operations according to various embodiments of the invention. For simplicity of explanation, not all of the possible customization operations are depicted, as such other possible operations can be ascertained by examination of the operations specifically shown in FIGS. 4-6. Moreover, it is to be appreciated that the format, layout, direction, content, and other characteristics of the ticker shown in FIGS. 4-6 are merely illustrative and that variations are possible.

In FIG. 4, a television set 400 is coupled to the client terminal 108 in a manner that allows a display screen 402 of the television set to show a television program 404. The television program 404 in this example is a basketball game. A ticker 406 is shown scrolling across the bottom of the display screen 402. The ticker 406 can be contained in a screen interface that overlays the television program 404, or the television program 404 may be scaled appropriately on the display screen 402 to fit the screen interface for the ticker 406 and thereby avoid the need for an overlay. An embodiment of the ticker 406 always displays the current time 421, although it is to be appreciated that exclusion of the current time 421 from being displayed is a possible customization option.

A user input device, such as a wireless remote control 410, is in communication with the client terminal 108 (via the wireless interface 318) to perform conventional television-viewing operations and also to control operation of the ticker 406 according to an embodiment of the invention, including customization operations. The remote control 410 includes a numeric keypad 412 that the viewer can use to select television channels. In an embodiment, the remote control 410 can include a ticker button 414, which if pressed, causes a command to be sent to the client terminal 108 to instruct the ticker software to render the ticker 406 on the display screen 402. If the ticker button 414 is pressed again, the ticker 406 is taken off the display screen 402. Alternatively or in addition, a TV button 422 can be pressed to dismiss the ticker 406 and return to full-screen television mode. The remote control 410 may also have an OK button 419 that can be used to perform various operations.

In the example of the ticker 406 in FIG. 4, the ticker 406 is scrolling from right to left (as symbolically depicted by an arrow 408). It is to be appreciated that in other embodiments, the ticker 406 may be scrolling in different directions and may also be positioned differently on the display screen 402, which can be the result of user customization. For the sake of illustration, the ticker 406 is shown as being set in a cycle where it is presenting NFL™ football sports scores (e.g., “Rams 3, Patriots 14” is the current moving ticker text item 409 that is being displayed for a “Sports” category 420 and an NFL subcategory 405). There may be any suitable number of categories and subcategories through which the user can navigate. A content gauge 411 can provide the viewer with a visual indication as to the total amount of ticker items in a particular subcategory, the amount remaining to be scrolled, the amount that has already been scrolled, and so forth.

FIG. 4 illustrates an example where the viewer has performed an exclusion of certain ticker topics (e.g., categories, subcategories, or items). In the specifically illustrated example, the viewer has excluded a subcategory 407, such that the NFL™ subcategory 405 showing NFL™ scores (and updates thereof) are the only moving text items 409 that the ticker 406 will cycle through, followed by scores from an NHL™ subcategory 413. In operation, the ticker 406 will present all of the ticker items from the NFL™ subcategory 405 and then “jump to” the NHL™ subcategory 413, thereby skipping and not presenting the ticker items from the excluded subcategory 407.

Once the ticker 406 has finished scrolling the ticker items from the non-excluded subcategories 405 and 413 of the Sports category 420, the ticker 406 will begin scrolling ticker items from subcategories of a next category 417, such as weather or finance. It is to be appreciated that the viewer may choose to exclude categories, as well as subcategories. Therefore in the context of FIG. 4, the ticker 406 will continue to repetitively scroll ticker items from the non-excluded sports subcategories 405 and 413 if the viewer has chosen to exclude the category 417. In yet another embodiment, the viewer can choose to exclude certain ticker items. Thus in the context of FIG. 4, the viewer may choose to exclude all scores except for the Rams/Patriots score displayed in the ticker item 409. If this is the case, then subsequent ticker item(s) 415 having scores from other games are not scrolled. Rather, the ticker 406 only cycles the ticker item 409, changing its presented content as updates are received.

In one embodiment, the ticker data corresponding to excluded ticker items are still received from the distribution server 218 and stored by the client terminal 108, but are not displayed until the exclusion is removed. In other embodiments, the ticker data corresponding to excluded topics is not received from the distribution server 218 until the exclusion is removed-the to-be-excluded ticker data remains at the distribution server 218 if that server is notified of the exclusion by the client terminal 108.

In one embodiment, selection of the ticker category, subcategory, or item for exclusion may be performed via a stationary navigation control 424 in the form of a “center focus” box. As an example, the subcategories 405, 407, and 413 sequentially scroll through the center focus box-the “navigation” performed in this sense is done by having these subcategories scroll into the stationary center focus box, rather than actively moving the center focus box to a particular subcategory. When a particular subcategory comes into center focus, the items corresponding to that subcategory begin scrolling. Once a subcategory comes into center focus, the user can press a button or combination of buttons on the remote control 410 to initiate the exclusion the items in the subcategory. Then the ticker skips to the next subcategory, and the viewer has the option of excluding that subcategory as well. This process repeats until the viewer has finished selecting subcategories for exclusion using the center focus box. When the viewer has finished selecting sub categories for exclusion, the ticker 406 scrolls only the non-excluded subcategories through the center focus box, and “skips” over the excluded subcategories.

In another embodiment, the user may use arrow keys 416 on the remote control 410 to navigate through the categories, subcategories, and items in the ticker 406, such as via the navigation control 424 in the form of a movable selection rectangle, when choosing categories, subcategories, or items to exclude. For example, right-left arrow keys may be used to navigate through the subcategories, while up-down arrow keys may be used to navigate through items under each subcategory or through categories. Once the navigation control 424 is positioned over an item to be excluded, the user can press a button or combination of buttons on the remote control 410 to initiate the exclusion.

Various other possible navigation implementations are possible when deciding which topic to exclude. As an example, a viewer may move through each category by way of all the subcategories. Categories are momentarily displayed in the vertical axis and then settle in the panel or other location to the left of the television program 404 while that category is active, as depicted in FIG. 4 for the Sports category 420.

With regards to the subcategories, the right-left arrow keys on the remote control 410 can bring any subcategory to be excluded into center focus without having to select a category first, in one example embodiment. The right-left or the up-down arrow keys may also be used to select items within a subcategory for exclusion.

Once something is excluded, such as the subcategory 407, that excluded subcategory is “grayed out” (or otherwise made to look different than non-excluded material) in an embodiment, and its corresponding ticker items are not scrolled. For instance in FIG. 4, the grayed-out subcategory 407 can comprise scores from the NBA™. As another example, the grayed out category 417 can be the weather category. Alternatively or in addition to the arrow keys 416, buttons 418 can also be used for navigation for purposes of choosing material to be excluded. These buttons 418 can comprise buttons that are similar to play, rewind, fast forward, pause, etc. buttons usable for recording devices. Moreover, it is to be appreciated that in one embodiment, excluded material is completely removed from the screen interface of the ticker 406, and so is not even displayed in grayed out format.

Various actions can be used to re-include an excluded category, subcategory, or item. To re-include a subcategory, for example, the viewer can press the right or left arrow key to navigate to a grayed out subcategory, and then press one or a combination of buttons on the remote control 410 to re-include that subcategory.

FIG. 5 illustrates another user customization example related to exclusion of topics. In this example, the user has chosen to customize the ticker 406 such that when the ticker 406 scrolls through the sports category 420 and the NFL™ subcategory 405, a “postgame” mode 500 is in effect. In the postgame mode 500, moving text items 409 and 502 display only final scores. Other modes may be available, such as pre-game and in-progress, but in this example, the particular user is concerned only with final scores. Enhancements, such as highlighting the winners of games, can be implemented.

Different techniques can be used to set the postgame mode 500 of FIG. 5. In one example embodiment, when the category 405 comes into center focus, the viewer can press one or a combination of buttons on the remote control 410 to bring up a menu where mode selections can be made. Alternatively or in addition, the viewer may set the mode by pressing the 1, 2, or 3 buttons on the remote control 410 when the subcategory 405 comes into center focus, thereby setting the postgame, pre-game, or in-progress modes, respectively.

FIG. 6 illustrates an embodiment of an “auto-mode,” where the ticker 406 is cycling through topics in its default mode. In one embodiment, the ticker 406 goes to the auto-mode if the user explicitly re-includes all excluded material in the ticker 406 The example of FIG. 6 illustrates an auto-mode where the ticker 406 is sequentially cycling through subcategories of the sports category 420. The ticker 406 has almost completed cycling football scores from the NFL™ subcategory 405, and is beginning to cycle basketball scores from the NBA™ subcategory 407. As illustrated, the ticker 406 is transitioning from a moving text item 502 for a football score to a moving text item 600 for a basketball score, and the content gauge 411 indicates that the first basketball score is being presented.

Various other customization features may be performed without use of a static preferences screen. For instance, components of the ticker 406 (such as the scrolling text items themselves, graphics, category and subcategory tabs, and so forth) may be relocated by the user. A “click and drag” feature may be used to move ticker components around the display screen 402. Traffic reports, stock information, weather reports, and other ticker categories can be customized based on user data, which may be obtained implicitly (e.g., by determining the zip code associated with the installed client terminal 108) or by processing data explicitly provided by the user (such as via a filled out profile or data entered by the user through the ticker screen interface). The settings related to the various customizations performed by the viewer may be saved in the storage medium 322, so as to avoid the need to re-customize the ticker 406 each time the user presses the ticker button 414 to render the ticker 406. In this manner, previously excluded ticker topics remain excluded, unless specifically re-included.

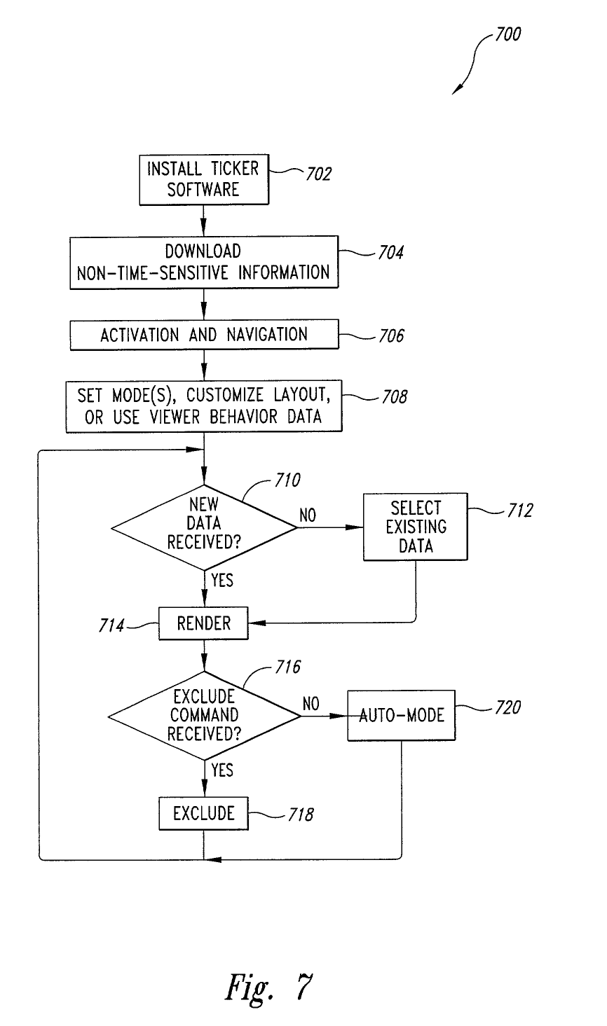

FIG. 7 is a flowchart 700 illustrating user customization of a ticker in accordance with an embodiment of the invention. At least some of the elements of the flowchart 700 can be embodied in software or other machine-readable instruction stored in a machine-readable medium, such as at the client terminal 108 or remotely at a server. Moreover, it is appreciated that the various operations shown in the flowchart 700 need not necessarily occur in the exact order shown.

Beginning at a block 702, ticker software, including upgrades or new components, is installed in the client terminal 108, for instance. In one embodiment, the ticker software can be factory installed or installed via download. According to an embodiment, components of the ticker software may already be installed, but are not activated until the user subscribes to the ticker service with the cable service provider. Once the ticker software is installed and once the user has subscribed to receive the ticker service, non-time-sensitive ticker information (such as graphics, updated menu selections, less-frequently updated ticker items, and so on) can be downloaded at a block 704. The download at the block 704 can occur during low-bandwidth-utilization hours (such as late at night), during commercial breaks, while the television set 400 is turned off, or other convenient times.

The ticker 406 is activated and navigated through at a block 706. As described above, activation of the ticker 406 may be performed by activating (such as pressing) the ticker button 414 on the remote control 410. Navigation through the categories, subcategories, and items may be done via the arrow keys 416.

Once activated, the user can perform some customization at a block 708. This customization can include setting modes (such as depicted in FIG. 5), and customizing the layout of the ticker 406 by moving or resizing components of the ticker 406 by clicking and dragging. Content of the ticker may also be customized at the block 708 by having the user explicitly enter data (such as a destination for which traffic information is desired) through the ticker screen interface, or such data may be obtained automatically and implicitly. In one embodiment, viewer behavior data may be used for customization. For example, if viewer behavior data implicitly collected from the client terminal 108 (using techniques familiar to those skilled in the art) indicates that the viewer never views weather or finance categories in the ticker 406 or in television channels, the distribution server 218 can refrain from sending data related to these ticker categories to the client terminal 108. Alternatively or in addition, the distribution server 218 can signal the ticker software to exclude these topics from the ticker 406. Still alternatively or in addition, the ticker software can exclude these topics independently of instructions from the distribution server 218, if the ticker software is given access to and processes the implicit data to determine which topics are appropriate for exclusion.

Ticker data is received at a block 710 via the techniques and communication paths described with reference to FIG. 3. It is also determined at the block 710 whether new ticker data to replace older ticker data is received, such as updated sports scores or weather reports. If no new ticker data is received, the existing ticker data is selected at a block 712. New ticker data is rendered or otherwise presented at a block 714, such as through a ticker template, including any customizations that may have been performed at the block 708.

While scrolling the ticker 406 at the block 714, commands corresponding to exclusion of ticker categories, subcategories, or items may be issued by the user from the remote control 410. At a block 716, the ticker software identifies whether an exclusion is requested and if so, the specific component of the ticker 406 that is to be excluded. The ticker software can then exclude (such as by graying out) the other components of the ticker at a block 718, and cause the ticker 406 to cycle only through the non-excluded components. Cycling through the non-excluded components involves checking for new data at the block 710, and rendering the appropriate ticker item at the block 714.

If re-inclusion of an excluded component of the ticker 406 is initiated, using the techniques described above, the ticker 406 can revert to the auto-mode at a block 720 or perform other re-inclusion. Thereafter, the ticker 406 will check for new data at the block 710, and cycle through the non-excluded categories, subcategories, and items at the block 714.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

As an example, a satellite television (TV) delivery system may be implemented alternatively or in addition to a cable distribution system. A satellite TV delivery system may comprise a direct broadcast satellite (DBS) system. A DBS system may comprise a small 18 inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center (e.g., analogous to the head-end 106) may be used to gather programming content, ensure its digital quality, and transmit the signal up to the satellites. Programming may come to the broadcast center from content providers (TBS™, HBO™, CNN™, ESPN™, etc.) via satellite, fiber optic cable, and/or special digital tape. Satellite-delivered programming is typically immediately digitized, encrypted and uplinked to the orbiting satellites. The satellites retransmit the signal back down to every earth-station—or, in other words, every compatible DBS system receiver dish at customers' homes and businesses.

Some programs may be recorded on digital videotape in the broadcast center to be broadcast later. Before any recorded programs are viewed by customers, technicians may use post-production equipment to view and analyze each tape to ensure audio and video quality. Tapes may then be loaded into a robotic tape handling system, and playback may be triggered by a computerized signal sent from a broadcast automation system. Back-up videotape playback equipment may ensure uninterrupted transmission when appropriate.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
in response to a received user command, customizing a manner of presentation of moving text items on a display screen, through a same screen interface that is configured to present the moving text items;
receiving data, corresponding to the moving text items, from an interactive video casting system; and
presenting the received data on the display screen as the moving text items in accordance with the customization.

2. The method of claim 1 wherein the data is presented as the moving text items on the display screen in response to a first user activation of a button on a user input device, and wherein a second user activation of a button on the user input device removes the moving text items from the display screen.

3. The method of claim 1, further comprising presenting graphics along with the moving text items.

4. The method of claim 1, further comprising displaying a current time along with the moving text items.

5. The method of claim 1 wherein customizing the manner of presentation of the moving text items comprises excluding at least some of the moving text items from presentation.

6. The method of claim 5, further comprising organizing the moving text items according to categories and subcategories, wherein excluding at least some of the moving text items from presentation comprises:
navigating to one of the categories to be excluded;
excluding the navigated category in response to another received user command; and
presenting moving text items organized under other categories.

7. The method of claim 5, further comprising organizing the moving text items according to categories and subcategories, wherein excluding at least some of the moving text items from presentation comprises:
navigating to one of the categories;
navigating to one of the subcategories, to be excluded, under that category;
excluding moving text items organized under the navigated subcategory from presentation in response to another received user command; and
presenting moving text items organized under other subcategories.

8. The method of claim 5, further comprising organizing the moving text items according to categories and subcategories, wherein excluding at least some of the moving text items from presentation comprises:
navigating to one of the categories;
navigating to one of the subcategories under that category;
navigating to one of the moving text items, to be excluded, under that subcategory;
excluding that moving text item from presentation in response to another received user command; and
presenting other moving text items.

9. The method of claim 5, further comprising displaying a category or subcategory corresponding to excluded moving text items in a manner different than a category or subcategory corresponding to presented moving text items.

10. The method of claim 9, further comprising including the excluded moving text items by selecting the category or subcategory displayed in a different manner.

11. The method of claim 9 wherein displaying the category or subcategory corresponding to excluded moving text items in a different manner comprises graying out the category or subcategory corresponding to the excluded moving text item, and wherein presenting the received data on the display screen as the moving text items in accordance with the customization includes skipping over the grayed out category or subcategory.

12. The method of claim 1 wherein customization of the manner of presentation of the moving text items comprises setting a mode under which the moving text items are presented.

13. The method of claim 1, further comprising saving a setting corresponding to the command related to presentation of the moving text items.

14. The method of claim 1 wherein customizing the manner of presentation of the moving text items is performed based on viewer behavior data.

15. The method of claim 1, further comprising removing the customization of the presentation of the moving text items in response to a navigation operation.

16. An article of manufacture, comprising:
a machine-readable medium having instructions stored thereon to:
customize a manner of presentation of moving text items on a display screen, through a same screen interface that is configured to present the moving text items, in response to a received user command; and
present data, corresponding to the moving text items and received from an interactive video casting system, on the display screen as the moving text items in accordance with the customization.

17. The article of manufacture of claim 16 wherein the instructions to customize the manner of presentation of the moving text items on the display screen include instructions to exclude some of the moving text items from presentation on the display screen.

18. The article of manufacture of claim 17 wherein the machine-readable medium further includes instructions stored thereon to include the excluded moving text items in response to a navigation operation.

19. The article of manufacture of claim 16 wherein the instructions to customize the manner of presentation of the moving text items on the display screen include instructions to base the customization on viewer behavior data.

20. An apparatus, comprising:
a means for customizing a manner of presentation of moving text items, through a same screen interface that is configured to present the moving text items, in response to a received user command;
a means for receiving data, corresponding to the moving text items, from an interactive video casting system; and
a means for presenting the received data on the display screen as the moving text items in accordance with the customization.

21. The apparatus of claim 20 wherein the means for customizing the manner of presentation of the moving text items is located at a client terminal in communication with the interactive video casting system.

22. The apparatus of claim 20 wherein the means for customizing the manner of presentation of the moving text items is located at a server in the interactive video casting system.

23. The apparatus of claim 20 wherein the means for presenting the received data on the display screen as the moving text items in accordance with the customization includes a means for excluding at least some of the moving text items.

24. A ticker for a video casting system, the ticker comprising:
a screen interface to present a plurality of movable text items, corresponding to data received from the video casting system, along with a video program; and
a customization feature, capable of activation via the screen interface that presents the movable text items, to allow customization of presentation of the movable text items in the screen interface.

25. The ticker of claim 24 wherein the customization feature allows exclusion of at least some of the movable text items.

26. The ticker of claim 24, further comprising:
a plurality of categories and subcategories, wherein the plurality of movable text items are organized under the subcategories; and
a navigation control to navigate among the categories, subcategories, and movable text items, wherein activation of a first set of keys on a user input device causes navigation between categories, wherein activation of a second set of keys on the user input device causes navigation through movable text items in one of the subcategories, and wherein activation of a button on the user input device selects at least one movable text item for presentation and excludes other movable text items from presentation.

27. The ticker of claim 26, further comprising a default mode, wherein the default mode is entered from a customized mode in response to navigation from a category or subcategory corresponding to an excluded movable text item to a category or subcategory corresponding to a presented movable text item.

28. The ticker of claim 26 wherein activation of the button on the user input device in conjunction with navigation to one of the subcategories via the second set of keys causes presentation of movable text items associated with that subcategory, and wherein activation of the button on the user input device in conjunction with navigation to one of the movable text items under any one of the subcategories results in continued presentation of that movable text item and exclusion of all other movable text items from presentation.

29. The ticker of claim 24 wherein the customization feature includes one of a feature to move a component, a feature to add user-specified data, a feature to resize a component, a feature to set a mode, a feature to base the customization on implicit user profile data, and a feature to base the customization on explicit user profile data.

30. The ticker of claim 24 wherein the customization feature comprises a feature to allow exclusion of ticker components, the ticker further comprising a navigational tool positioned in the screen interface to coincide with ticker components to be selected for exclusion in response to a user command.

31. The ticker of claim 24 wherein activation of a button on a user input device renders the screen interface on a display screen.

32. An apparatus for a video casting system, the apparatus comprising:
an interface to receive data sent from the video casting system;
a storage medium coupled to the interface to store a software program;
a processor, coupled to the storage medium and to the interface, to cooperate with the software program to format the received data as a corresponding plurality of movable text items; and
an output section to provide the plurality of movable text items to a display screen configured to present the plurality of movable text items through a screen interface, the software program including code to allow user customization of presentation, via the screen interface, of the movable text items.

33. The apparatus of claim 32 wherein the code to allow user customization of the presentation of the movable text items includes code to exclude at least some of the movable text items from presentation in response to navigation through the screen interface.

34. The apparatus of claim 32 wherein the code to exclude at least some of the movable text items from presentation includes code to include these excluded movable text items in response to navigation to their respective categories or subcategories via the screen interface.

35. A video casting system, comprising:
a source of data; and
an apparatus coupled to the source, the apparatus including:
an interface to receive data sent from the video casting system;
a storage medium coupled to the interface to store a software program;
a processor, coupled to the storage medium and to the interface, to cooperate with the software program to format the received data as a corresponding plurality of movable text items; and
an output section to provide the plurality of movable text items to a display screen configured to present the plurality of movable text items through a screen interface, the software program including code to allow user customization of presentation, via the screen interface, of the movable text items.

36. The system of claim 35 wherein the apparatus comprises a server.

37. The system of claim 35 wherein the apparatus comprises a client terminal.

38. The system of claim 35 wherein the code to allow user customization of the presentation of the movable text items includes code to exclude at least some of the movable text items from presentation in response to navigation through the screen interface.

39. The system of claim 35 wherein the source of the data comprises:
a feed server to receive a plurality of feeds of data and having a feed engine to manipulate the data received from the feeds;
a production server coupled to the feed server to receive the data manipulated by the feed engine, and coupled to a database having tables for the manipulated data received from the feed server, the production server being capable to change a format of the manipulated data to a format compatible with client terminals configured to present the movable text items on the display screen; and
a distribution server to send the manipulated data having the format compatible with the client terminals, the movable text items displayed on the display screen corresponding to that manipulated data.

40. A method usable in a video casting system, the method comprising:
in response to a received user command, customizing a manner of presentation of moving text items, through a same screen interface that is configured to present the moving text items;
receiving data, corresponding to the moving text items, from an interactive video casting system,
wherein a client terminal for a television for the video casting system is coupled to present the received data, through the screen interface on a display screen of the television, as the corresponding moving text items,
wherein the video casting system includes a plurality of sources, which provide the data, communicatively coupled to a plurality of broadcast centers,
wherein the broadcast centers are coupled to a server capable to provide the data from the sources to the client terminal, and
wherein the interactive video casting system is capable to provide the data to the client terminal via different communication channels, including at least one of a plurality of television broadcast channels, an out-of-band channel, and a communication channel with a communication network; and
presenting the received data on the display screen as the moving text items in accordance with the customization, the customization including a feature to exclude at least some of the movable text items from presentation.

41. The method of claim 40 wherein the broadcast center comprises part of a satellite television delivery system.

42. The method of claim 40 wherein the video casting system comprises an interactive television system.

43. A video casting system, comprising:
a source of data including:
a feed server to receive a plurality of feeds of data and having a feed engine to manipulate the data received from the feeds;
a production server coupled to the feed server to receive the data manipulated by the feed engine, and coupled to a database having tables for the manipulated data received from the feed server, the production server being capable to change a format of the manipulated data to a format compatible with client terminals configured to present the movable text items on a display screen; and
a distribution server to send the manipulated data having the format compatible with the client terminals, the movable text items displayed on the display screen corresponding to that manipulated data; and
an apparatus coupled to the distribution server of the source, the apparatus including:
an interface to receive data sent from the video casting system;
a storage medium coupled to the interface to store a software program;
a processor, coupled to the storage medium and to the interface, to cooperate with the software program to format the received data as a corresponding plurality of movable text items; and
an output section to provide the plurality of movable text items to a display screen configured to present the plurality of movable text items through a screen interface, the software program including code to allow user customization of presentation, via the screen interface, of the movable text items.

44. The system of claim 43 wherein the apparatus comprises one of the client terminals.

45. The system of claim 43 wherein the apparatus comprises a server remote from the client terminals.

46. The system of claim 43 wherein customization of the presentation includes exclusion of at least some of the movable text items from presentation.
